(19) United States
(12) Patent Application Publication
(10) Pub. No.: US 2006/0075151 A1
(43) Pub. Date: Apr. 6, 2006

(54) Mp3 walkman with a replaceable hard disk

(76) Inventor: Hui Lin, Taiwan (CN)

Correspondence Address: Pro-techtor International, 20775 Norada Court, Saratoga, CA, 95070-3018, US

(21) Appl. No.: 10/523,507

(22) PCT Filed: Aug. 8, 2002
(86) PCT No.: PCT/CN02/00550

§ 371 Date: Jan. 31, 2005

(51) Int. Cl. G06F 3/00

(52) U.S. Cl. 710/15; 710/72

(57) ABSTRACT

An audio player with an exchangeable hard drive as storage device, which is used to play audio files, comprises a main body, a power supply, an exchangeable hard drive, and a main PCB. The main PCB is installed inside the main body and comprises a set of golden fingers, which connects to a set of pins of a drive PCB of the hard drive to communicate. The main PCB further comprises: a processing unit, which receives commands form the functional buttons via the receiver circuit, and accesses audio files in the hard drive through a buffer; a decoding unit, which receives audio files from the processing unit to decode; a D/A converter, which converts received decoded audio files from digital signals to analog signals; and an amplifier, which amplifies received analog signals and transfers to an output unit.

### BACKGROUND OF THE INVENTION

1. Field of the Invention

The present invention relates to a portable audio player, which particularly relates to a portable audio player with an exchangeable hard drive that can easily exchange.

2. Description of the Related Art

Nowadays many kinds of technologies of multimedia are developing to serve more consumers. Besides commercial and home multimedia devices set in a room, portable multimedia applications are wide used and consumed in the market. Audio player (like Walkman) is one of the earliest portable multimedia devices. Since cassette tape, compact disc (CD), and mini disc (MD), the volume of the portable audio player is getting smaller and smaller. The latest and smallest modern portable audio player is a kind of MP3 (MPEG Audio Layer 3) player utilizing Flash Memory or other storage devices like hard drive. The most advantage of the MP3 or other audio compressing file is smaller in file size. A sound file in one-second time, sampling in 16 bits, 44.1 KHz, is 172 KB (Kilobyte), so that a normal 80 minutes audio CD take 700 MB (Megabyte) capacity. The MP3 technique, for example, can compress the data of audio CD into 1/12 size with only few loss of quality. That means the same capacity can store more to 12 times long music. This advantage makes MP3 become a standard that related industry develops and supports.

MP3 file originally can only be played via PC (Personal Computer) or portable computer like notebook. As the flash memory is utilized in the player as storage device, MP3 today can be played by a Walkman, a digital camera, and even by a wristwatch. However, the flash memory is still much more expensive than the cassette, CD, or MD, and so that a player utilizing fixed flash memory can only play music in storage depending on the memory size, and even has less playing time than a CD or MD. This kind of player in the prior art needs to download to replace with new files frequently, and also still leans on the computer.

### SUMMARY OF THE INVENTION

The primary object of the present invention is to provide an exchangeable hard drive or other storage device utilized in an audio player. With exchanging the exchangeable hard drives that store different music files, the audio player of the present invention can portably play more music than players with fixed memory in the prior art.

Another object of the present invention is to provide the audio player with exchangeable hard drive, wherein the hard drive comprises a USB (Universal Serial Bus) plug that compatible the PnP (Plug and Play) to download audio files from a computer.

A further object is to provide a set of golden fingers on a PCB (Printed Circuit Boards) in a main body of the audio player. The golden fingers connect with a PCB of the hard drive to communicate.

To achieve the above objects, the audio player of the present invention comprises:

a main body, which comprises a set of functional buttons to operate the player, a socket in which a USB plug of a hard drive plugs, and a slot which is open and contact with the hard drive;

a power supply, which is set inside the main body;

a storage device, which comprises a USB plug at one side, a drive PCB, and a set of pins extended from the drive PCB and protruding on the surface thereof corresponding to the slot of the main body; and

a main PCB, which is installed inside the main body, and comprises a set of golden fingers, which is opened at the slot to connect with the pins, and a receiver circuit corresponding to the functional buttons.

Said main PCB comprises:

a processing unit, which receives commands form the functional buttons via the receiver circuit, and accesses audio files in the hard drive through a buffer;

a decoding unit, which receives audio files from the processing unit to decode;

a D/A (Digital/Analog) converter, which converts received decoded audio files from digital signals to analog signals; and

an amplifier, which amplifies received analog signals and transfers to an output unit.

### BRIEF DESCRIPTION OF THE DRAWINGS

FIG. 1 is a block diagram of the present invention;

FIG. 2 is a diagram of the front perspective view of the present invention;

FIG. 3 is a diagram of the back perspective view of the present invention;

FIG. 4 is a diagram of the exploded view of the present invention;

FIG. 5 is a diagram of the connection of the main PCB and the exchangeable hard drive of the present invention.

### DETAILED DESCRIPTION OF THE PREFERRED EMBODIMENTS

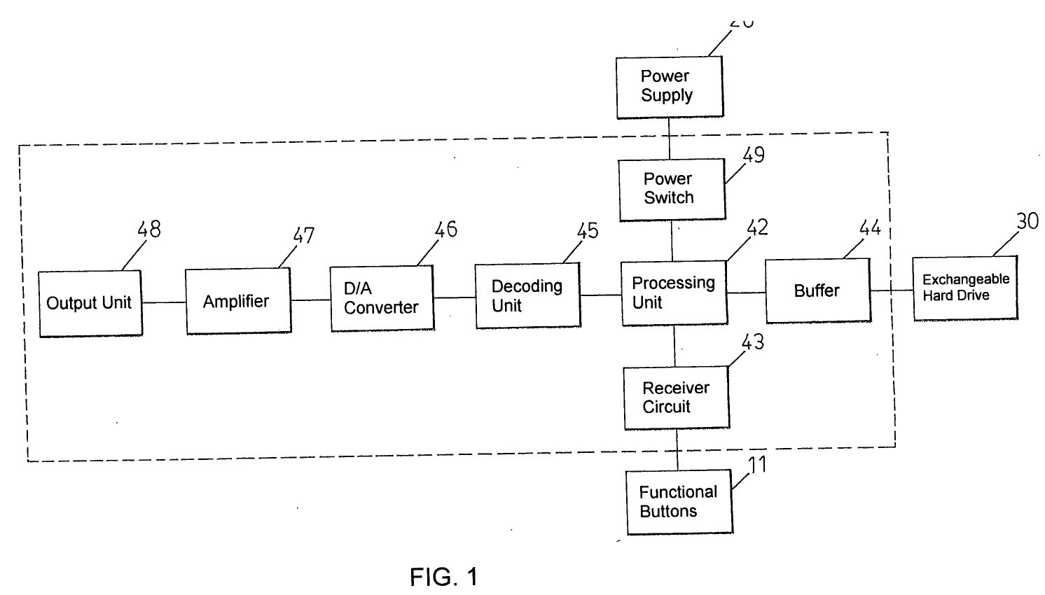

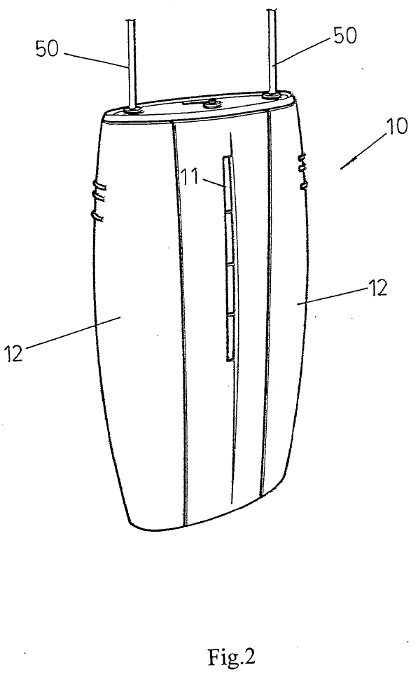

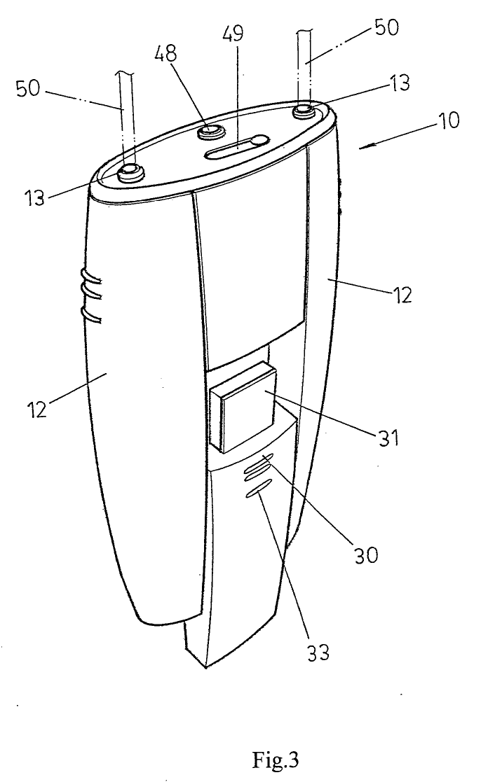

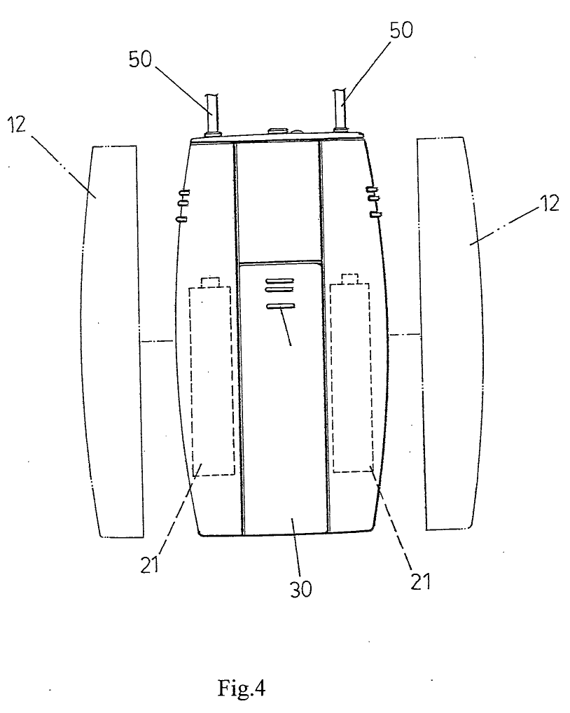

In the following description of the embodiments of the present invention, please refer to the drawings. As shown in FIG. 1, FIG. 2, FIG. 3, and FIG. 4, a portable audio player with exchangeable hard drive of the present invention comprises: a main body 10, a power supply 20, a exchangeable hard drive 30 as storage device, and a main PCB 40.

The main body 10 comprises a set of functional buttons 11 on the surface thereof which further comprises a play button, a stop button, and two directional buttons for users operating, a socket for a USB plug 31 of a exchangeable hard drive 30, a slot which is open and contact with the hard drive 30, and two strap holes 13 for a strap 50 (hand strap, neck strap, etc. for example).

A power supply 20 is located inside the main body 10. In an embodiment of the present invention the power supply 20 comprises a battery 21, and the main body 10 comprises a corresponding battery cover 12 for the battery 21 installing and replacing.

The hard drive 30 or a thumb drive in this embodiment comprises a USB plug 31 to plug into any computer comprising USB socket to download audio files, and further comprises a set of pins 32 corresponding to the slot of the main body 10. Also, a LED (Light Emitting Diode) 33 is set on and indicates status of the hard drive 30. Meanwhile, any kind of technologies of hard drives, like flash memory, hard disc, etc. for example, can be utilized as a storage device of the present invention.

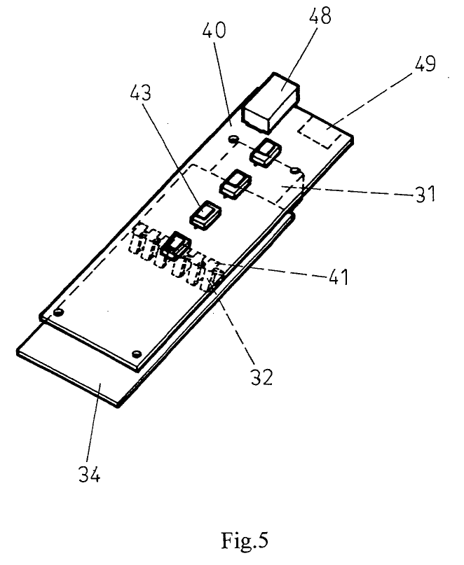

The main PCB 40 is installed inside the main body 10 and comprises a set of golden fingers 41 extended to the slot of the main body 10 as a contact with the pins 32 of the hard drive 30 to communicate, and a receiver circuit 43 (indicated in FIG. 1 and FIG. 5) corresponding to the functional buttons 11.

Please also refers to FIG. 1 and FIG. 5, the main PCB 40 further comprises:

a processing unit 42, which receives commands form the functional buttons 11 via the receiver circuit 43, and accesses audio files in the hard drive 30 through a buffer 44;

a decoding unit 45, which receives audio files from the processing unit 42 to decode;

a D/A (Digital/Analog) converter 46, which converts received decoded audio files from digital signals to analog signals; and

an amplifier 47, which amplifies received analog signals and transfers to an output unit 48; and

a power switch 49, which is extended to the surface of the main body 10 to operate the power supply 20 turning on/off.

The output unit 20 is an earphone socket in this embodiment, and can connect to an earphone or any other audio device, like home Hi-Fi system for example.

The foregoing describing of the preferred embodiments of the invention is for the purpose of illustration and description. It is not intended to exhaustive or to limit the invention to the precise from disclosed. Many other possible modifications and variations can be made without departing from the scope of the present invention, which following claims are depended.

What is claimed is:

1. An audio player which can exchange storage device to play audio files comprising:
a main body, which comprises a set of functional buttons on the surface thereof for operation, a USB socket, and a slot opening on the surface;
a power supply, which is installed in the main body as a power source;
an exchangeable hard drive, which comprises a USB plug for download and storage audio files from a computer, a drive PCB, and a set of pins extended from the drive PCB on the surface thereof corresponding to the slot of the main body; and
a main PCB, which is installed inside the main body and comprises a set of golden fingers extended through the slot to the surface of the main body to contact the pins of the exchangeable hard drive and communicate with the drive PCB, a receiver circuit corresponding to the functional buttons, and further comprises:
a processing unit, which receives commands form the functional buttons via the receiver circuit, and accesses audio files in the exchangeable hard drive through a buffer;
a decoding unit, which receives audio files from the processing unit to decode;
a D/A converter, which converts received decoded audio files from digital signals to analog signals; and
an amplifier, which amplifies received analog signals and transfers to an output unit.

2. An audio player according to the claim 1, which further comprises an output device to connect to the output unit to play audio.

3. An audio player according to the claim 2, wherein the output unit is an earphone socket.

4. An audio player according to the claim 1, wherein the main PCB further comprises a power switch, which is set on the surface of the main body and connects to the power supply for operating power on/off.

5. An audio player according to the claim 1, wherein the power supply comprises a battery, and the main body comprises a corresponding battery cover for the battery installing and replacing.

6. An audio player according to the claim 1, wherein the main body comprises a strap hole for a strap.

7. An audio player according to the claim 1, wherein the exchangeable hard drive comprises a LED to indicate status of operation.

8. An audio player according to the claim 1, wherein the functional buttons comprises a play button, a stop button, and two directional buttons.
